(19) United States
(12) Patent Application Publication
(10) Pub. No.: US 2007/0094637 A1
(43) Pub. Date: Apr. 26, 2007

(54) System, method, and computer program product for enabling coexistence of related software

(75) Inventor: Kent F. Hayes JR., Chapel Hill, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/256,844

(22) Filed: Oct. 24, 2005

(51) Int. Cl. G06F 9/44

(52) U.S. Cl. 717/106

(57) ABSTRACT

The present invention provides a method, system, and computer program product for enabling the coexistence of related software by providing source code classes in a library system, then extracting some classes from the library system, refactoring each extracted class into a source that is required by a tooling agent, thereby generating a tooling code from the refactored source.

### BACKGROUND OF THE INVENTION

1. Field of the Invention

The present invention generally relates to software, and more specifically relates to a system, method, and computer program product for enabling the coexistence of related software.

2. Related Art

There are situations wherein related software (e.g., software from, or derived from, the same ancestral source base) must be able to successfully coexist in an environment.

One such example of the need for coexisting software arises in the situation related to the use of an OSGi (Open Source Gateway Initiative) device management agent running on an OSGi runtime running on a device. The OSGi agent is used to communicate with one or more device management servers to enable/facilitate management of the device and associated software. Each management server may be a component in one or more products and/or tools which have the need to manage the device on which the aforementioned agent runs. The set of code (contained in the agent's bundles in the OSGi environment) is used to manage the various OSGi customer devices. It is further contemplated that the OSGi agent technology will also enable the tooling solution to manage and/or interact with a remote runtime.

For example, the tooling will often be used to debug a runtime that has another version (i.e., different code version) and/or “flavor” (i.e., different agents using core agent bundles) of the agent on it. Examples of core agent bundles include Linux, Win32, Fleetboard01, SampleOSGi, RCP, and the like. Typically, the customer may wish to utilize the tooling solution (which uses the tooling agent on the device) to debug the non-tooling agent along with any other software that may be present in the runtime environment. The agent used by the tooling must be able to successfully coexist on the same runtime with other agents utilizing and/or derived from the same code base.

However, concomitant with this contemplated scenario are shortcomings that are illustrated, by example, in the following figures. In FIG. 1 a tooling agent 10 incorporating, or using, a version 1 of a plurality of core bundles 30x₁ (e.g., core agent bundle A version 1 30A₁; core agent bundle B version 1 30B₁; and, core agent bundle C version 1 30C₁). Also, as illustrated, a Fleetboard01 agent 20A is utilizing the same version (i.e., same set) of core agent bundles 30A₁, 30B₁, 30C₁, as the tooling agent 10. Also, another (e.g., Win32) agent 20B is utilizing a different version of core agent bundles 30x₂ (e.g., core agent bundle A version 2 30A₂; core agent bundle B version 2 30B₂; and, core agent bundle C version 2 30C₂) than the tooling agent 10 and the Fleetboard01 agent 20A.

FIG. 2 depicts one scenario of what happens when the tooling agent 10 and one of the other agents 20 (e.g., Fleetboard01 20A) try to coexist during the same runtime. Although both the tooling agent 10 and the Fleetboard01 agent 20A are using the same core agent bundles 30x, they cannot successfully coexist on the same runtime because the agent 20 can only use one extension bundle 30xₙ, at a time.

Similarly, FIG. 3 depicts the scenario of what happens when the tooling agent 10 and the other agent 20B (e.g., Win32) try to coexist during the same runtime. Here the scenario will not work because the agent (i.e., Win32) 20B uses a later version (i.e., version 2) of the core bundles 30x_{n+y}. The OSGi runtime in this example will not support the use of different versions of the core agent bundles 30 (i.e., version 1 vs. version 2). Additional failure will happen because the agent extension bundles differ as well (See FIG. 2).

Although not depicted in the figures, having the tooling agent 10 use the later version of the bundle 30 will not work because of the agent extension bundle problem discussed above. Further, destabilization of the tooling can result if the tooling is required to run with a version of the core agent bundles 30 that it was not tested with. Similarly, the customer agent would be stabilized if it is used with a later version of the core agent bundles 30.

Thus, a need exists wherein the tooling agent 10 must be able to coexist successfully on the same runtime with other agents 20 using the same code base.

### SUMMARY OF THE INVENTION

The present invention provides a method, system, and computer program product for enabling coexistence of related software.

A first aspect of the present invention is directed to a method for enabling coexistence of related software, comprising: providing at least one source code class in a library system; extracting at least one source code class from the library system; refactoring each extracted class into a source required by an agent; and generating a code from the source.

A second aspect of the present invention is directed to a system for enabling coexistence of related software, comprising: a system for providing at least one source code class in a library system; a system for extracting at least one source code class from the library system; a system for refactoring each extracted class into a source required by an agent; and a system for generating a code from the source.

A third aspect of the present invention is directed to a program product stored on a computer readable medium for enabling coexistence of related software, the computer readable medium comprising program code for performing the steps of: providing at least one source code class in a library system; extracting at least one source code class from the library system; refactoring each extracted class into a source required by an agent; and generating a code from the source.

A fourth aspect of the present invention is directed to a method for deploying an application for enabling coexistence of related software, comprising: providing a computer infrastructure being operable to: provide at least one source code class in a library system; extract at least one source code class from the library system; refactor each extracted class into a source required by an agent; and generate a code from the source.

A fifth aspect of the present invention is directed to computer software embodied in a propagated signal for enabling coexistence of related software, the computer software comprising instructions to cause a computer system to perform the following functions: providing at least one source code class in a library system; extracting at least one source code class from the library system; refactoring each extracted class into a source required by an agent; and generating a code from the source.

A sixth aspect of the present invention is directed to a method for enabling coexistence of related software, comprising: providing at least one source code class in a library system; extracting at least one source code class from the library system; refactoring each extracted class into a source required by a software routine; and generating a code from the source.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a tooling agent and two other agents utilizing various versions of agent core bundles.

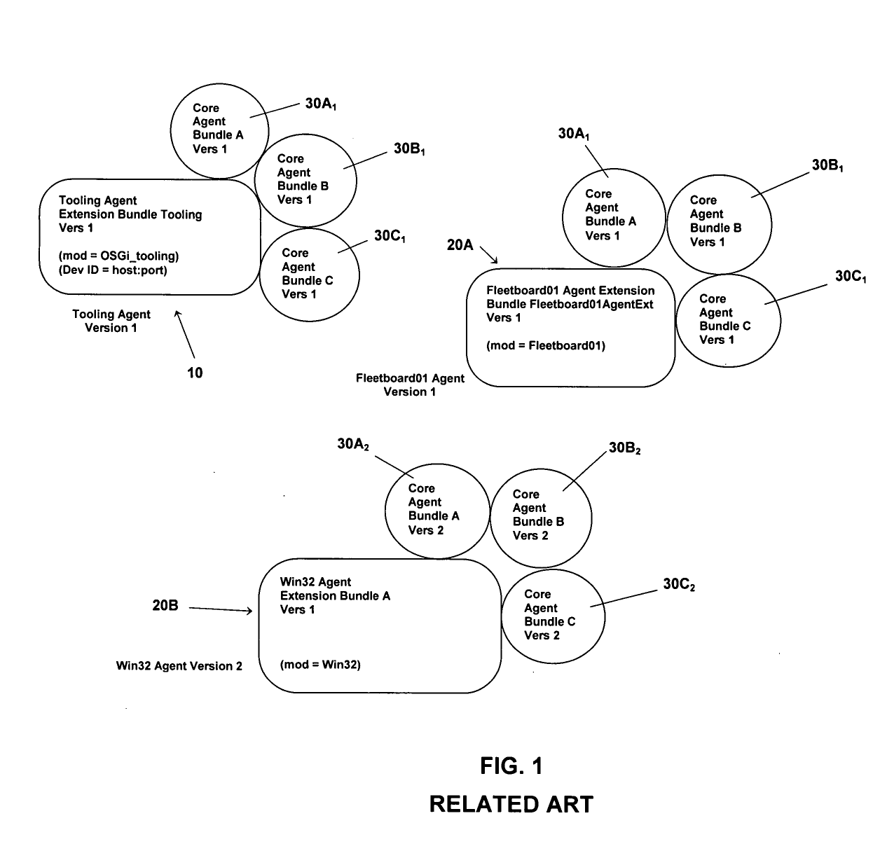

FIG. 2 depicts a tooling agent and Fleetboard agent attempting to use the same core agent bundles on the same runtime.

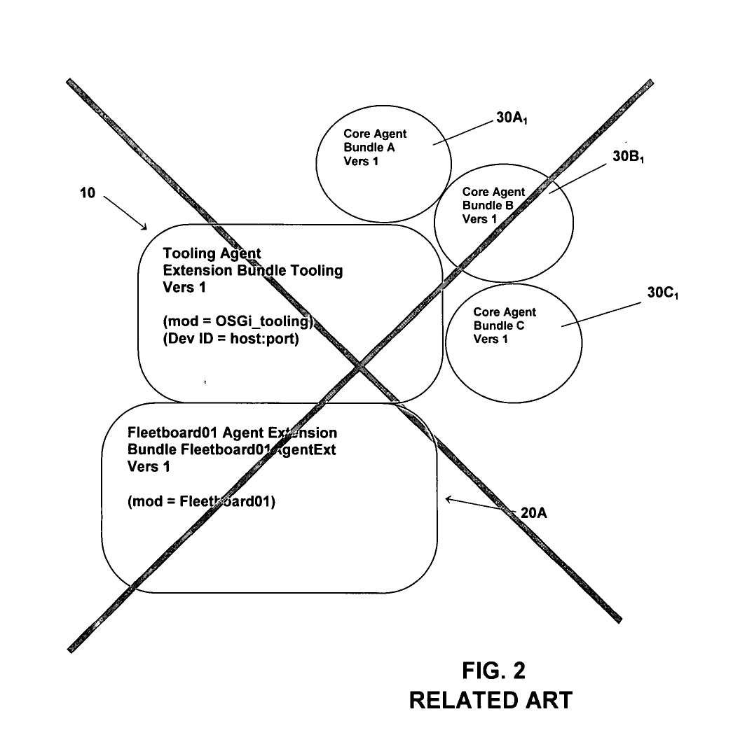

FIG. 3 depicts a tooling agent and Win32 agent attempting to use two different versions of core agent bundles on the same runtime.

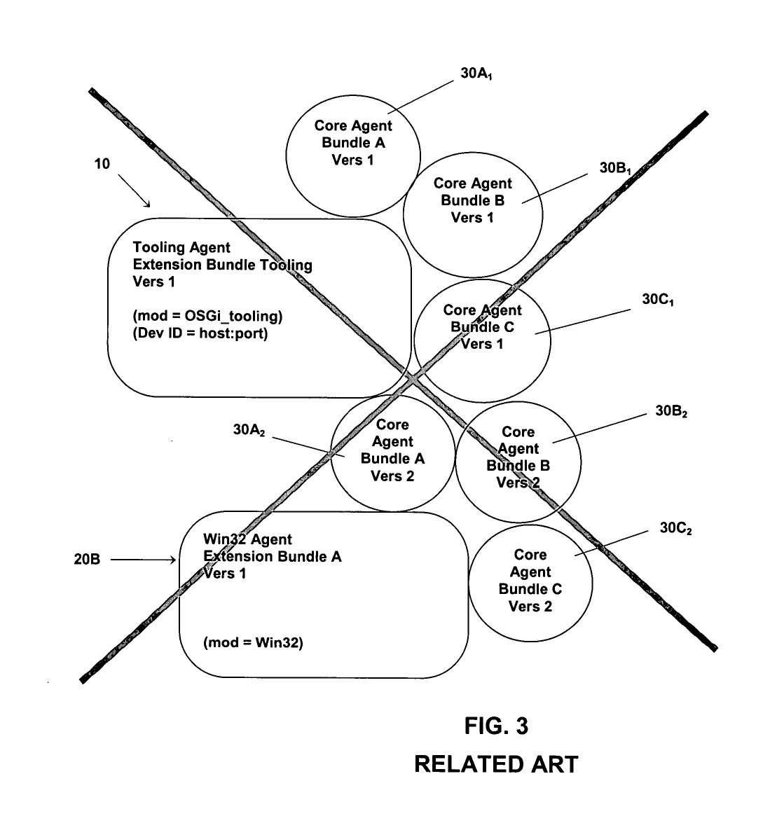

FIG. 4 depicts a portion of a system showing refactoring in accordance with an embodiment of the present invention.

FIG. 5 depicts a flowchart of a method in accordance with an embodiment of the present invention.

FIG. 6 depicts an illustrative computer system for implementing an embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

It is assumed that the reader has an understanding of Java, OSGi, agents, and the like, commensurate with one skilled in the art. Therefore, a detailed description of Java, OSGi, agents, and other Java-related systems/processes and OSGi-related systems/processes referenced in the present disclosure will not be provided herein.

When related software all derives from the same ancestral source base it would be helpful to enable these related software to successfully coexist.

By example only, one environment where this scenario is desirable is with an OSGi agent operating with a plurality of software products.

In Java-based applications, applets, and the like, the present invention provides for refactoring a tools agent during a build process by moving the tools agent to different Java packages so as to avoid conflicts with non-tooling versions of the agent.

The present invention includes moving the agent components to a tools specific package hierarchy. For example, in a Java-based application, the OSGi agent may be as follows:
Java package com\ibm\osg\service\osgiagentimpl

Under the present invention, this ultimately is changed so that the OSGi agent resides as follows:
com\ibm\tools\osg\service\osgiagentimpl

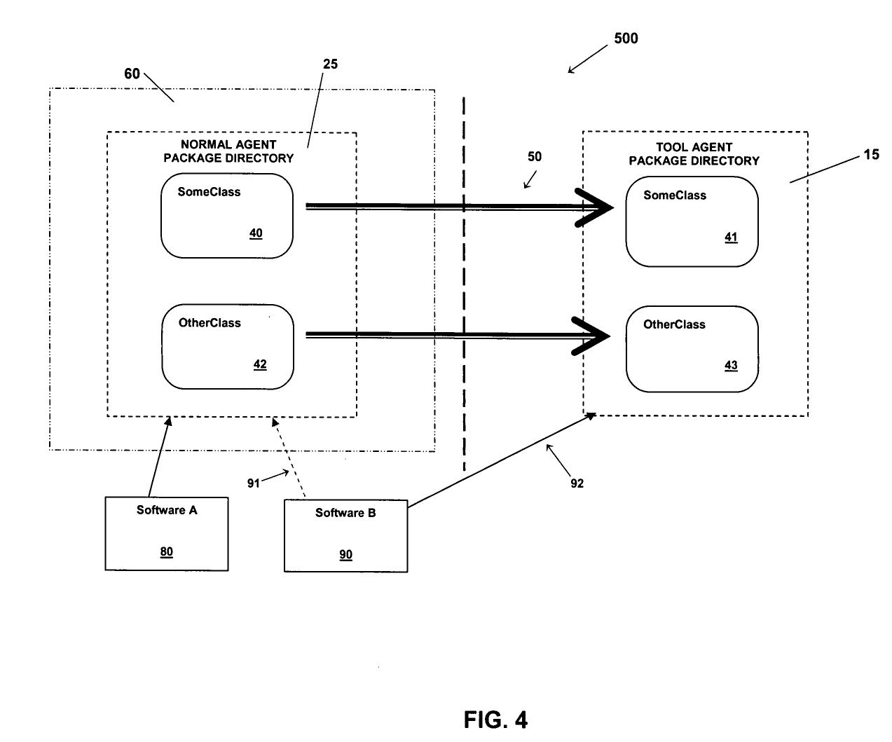

FIG. 4 depicts a system 500 that employs the method of the present invention. A library system 60 includes a first (e.g., normal agent package) directory 25 that includes one or more software files (e.g., Java classes 40, 42).

In an embodiment of the present invention, there may be a first class 40 (e.g., “SomeClass”) and a second class 42 (e.g., “OtherClass”) residing in the normal agent package directory 25. As part of the present invention these plurality of classes of software 40, 42 get extracted out of the normal agent package directory 25 of library system 60 and get refactored 50 into a second (e.g., tool agent package) directory 15. Thus, the SomeClass 40 gets refactored 50 into the SomeClass 41 in the tool agent package directory 15. Similarly, the OtherClass 42 gets refactored 50 into the OtherClass 43 in the tool agent package directory 15. As a result, software can mutually coexist wherein software (e.g., Software A) 80 that uses the first (e.g., “normal”) agent classes while software (e.g., Software B) 90 that uses the second (e.g., “tooling”) agent classes may do so concurrently as shown in FIG. 4. While Software B 90, previous to this invention would attempt to use classes only in the first (e.g. “normal”) agent package directory 25, as denoted by phantom arrow 91, now turns to the second (e.g., “tool”) agent package directory 15 to use classes, as denoted by arrow 92.

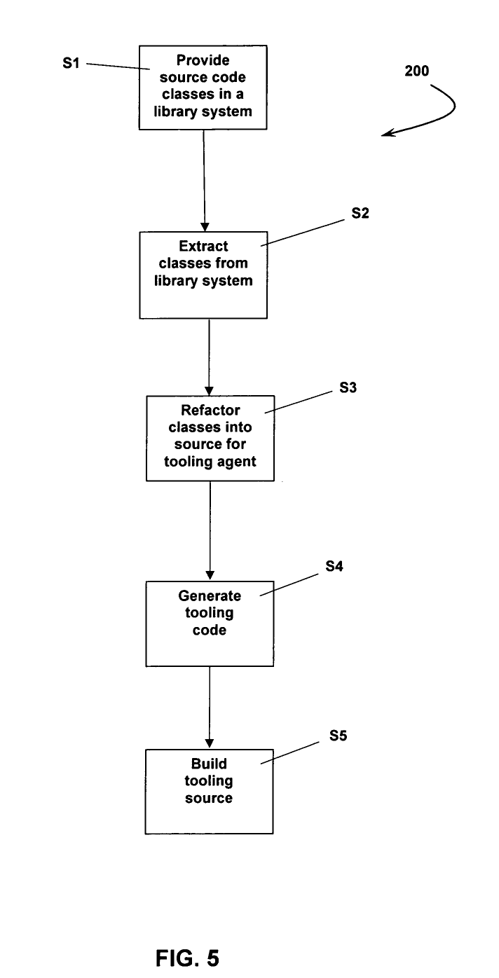

Turning to FIG. 5 which depicts an embodiment of a method 200, employing the steps of the present invention.

Step S1 includes providing at least one source code class in a library system. There may, for example, be two source code classes in the library system. There may be a first class (e.g., “SomeClass”) in a library system. For example, as depicted below this first class in the library system could be:

File SomeClass.java in com\ibm\normalAgentPackage directory
package com.ibm.normalAgentPackage
public class SomeClass {

void SomeFunction(int x, com.ibm.normalAgentPackage.SomeOtherClass soc) {

StepA(x);
StepB(soc);
StepC( );

}

:
:
:
}

For example, there may be a second source code class (e.g., “SomeOtherClass”) in the same library system. For example, as depicted below this second class could be as follows:

File SomeOtherClass.java in com\ibm\normalAgentPackage directory
package com.ibm.normalAgentPackage
public class SomeOtherClass {

:
:

Next, step S2 entails extracting (i.e., copying) some of the source code classes from the library system. For example, the first class (“SomeClass”) and the second class (“SomeOtherClass”) are extracted out of the library system.

Next, step S3 entails refactoring these extracted classes (i.e., first and second classes, respectively) into the source required by the agent. This agent may, for example, be a tooling agent. For example, the first class (“SomeClass”), under Step S3 may entail refactoring as follows:

File SomeClass.java in com\ibm\toolingAgentPackage directory
package com.ibm.toolingAgentPackage
public class SomeClass {

void SomeFunction(int x, com.ibm.toolingAgentPackage.SomeOtherClass soc) {

StepA(x);
StepB(soc);
StepC( );

}

:
:
:
}

Similarly, in Step S3, the second class (“SomeOther”) may be refactored as follows:

File SomeOtherClass.java in com\ibm\toolingAgentPackage directory
package com.ibm.toolingAgentPackage
public class SomeOtherClass {

:
:

}

Step S4 entails generating code from the source. For example, the code generated may be tooling code such as the following:

com\ibm\normalAgentPackage\SomeClass.java
com\ibm\normalAgentPackage\SomeOtherClass.java
com\ibm\toolingAgentPackage\SomeClass.java
com\ibm\toolingAgentPackage\SomeOtherClass.java

Finally, in Step S5 the tooling source is built thereby enabling the related software to coexist. For example, this step may entail compiling into .class files as follows:

com\ibm\normalAgentPackage\SomeClass.class
com\ibm\normalAgentPackage\SomeOtherClass.class
com\ibm\toolingAgentPackage\SomeClass.class
com\ibm\toolingAgentPackage\SomeOtherClass.class

The above steps depict one embodiment for refactoring code. Namely, taking the Java source code file, refactoring it in to an appropriate package structure for tooling (or software used for other purposes), and compiling it into .class files. The present invention contemplates another embodiment for refactoring code. That is taking the original code after it is built into .class files and then refactoring the .class files into another copy for the tooling code (or code used for other purposes). Both embodiments for refactoring ultimately achieve the same results (i.e., enabling coexistence of related software).

As FIG. 4 depicts, a first software A 80, which utilizes the normal agent and, hence, interacts with the classes in the normal agent class package directory 25 and uses the normal agent classes 40, 42 therein. Concurrently, the second software B 90, which utilizes the tooling agent, would instead utilize the tooling agent classes 41, 43 residing in the tooling agent package directory 15.

The method 200 of the invention is an improvement for many reasons. One example of this enhanced capability is show when a “bug” is found in software (e.g., the implementation of SomeClass.java). Under the present invention the bug need only be fixed in the implementation of the first class. Keeping with the example above, the bug need only be fixed in:
com\ibm\normalAgentPackage\SomeClass.java

This fix will automatically be applied to the relevant tooling software the next time the tooling software is built, or generated. This is because the tooling source is derived from the normal source before it is built.

As with the method discussed above, the files as stored in the library system would be as follows:

File SomeClass.java in com\ibm\normalAgentPackage directory
package com.ibm.normalAgentPackage
public class SomeClass {

void SomeFunction(int x, com.ibm.normalAgentPackage.SomeOtherClass soc) {

StepA(x);
StepB(soc);
StepZ_WHAT_WAS_FIXED( );

}

:
:
:
}

The second class of files in the library system would be as follows:

File SomeOtherClass.java in com\ibm\normalAgentPackage directory
package com.ibm.normalAgentPackage
public class SomeOtherClass {

:
:

As with the method 200 discussed above the files in the library system are extracted and refactored into the source needed for the tooling agent. For example, the refactored some class would become as follows:

File SomeClass.java in com\ibm\toolingAgentPackage directory
package com.ibm.toolingAgentPackage
public class SomeClass {

void SomeFunction(int x, com.ibm.toolingAgentPackage.SomeOtherClass soc) {

StepA(x);
StepB(soc);
StepZ_WHAT_WAS_FIXED( );

}

:
:
:
}
and, similarly, the second class would be refactored as follows:
File SomeOtherClass.java in com\ibm\toolingAgentPackage directory
package com.ibm.toolingAgentPackage
public class SomeOtherClass {

:
:

}

The tooling source can then be built which coexists with the associated normalAgentSource. Hence, the following class files are generated.

com\ibm\normalAgentPackage\SomeClass.class
com\ibm\normalAgentPackage\SomeOtherClass.class
com\ibm\toolingAgentPackage\SomeClass.class
com\ibm\toolingAgentPackage\SomeOtherClass.class

The present invention ultimately provides the advantage of enabling the mutual coexistence of related software.

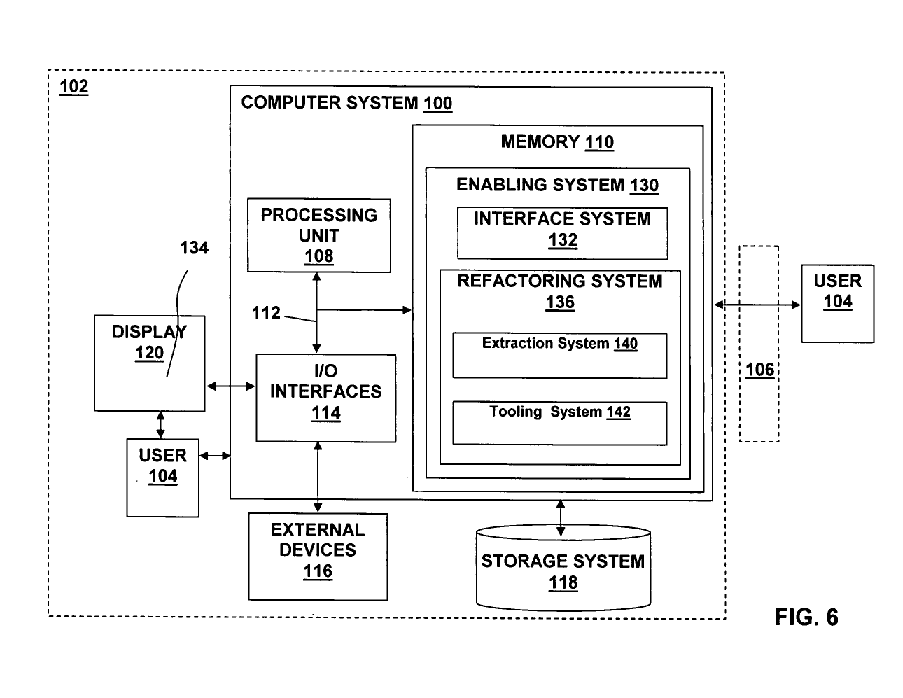

A computer system 100 for enabling the coexistence of related software in accordance with an embodiment of the present invention is depicted in FIG. 6. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a service for enabling coexistence of related software in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as enabling system 130, that is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 6 can be included in computer system 100. However, if computer system 100 comprises a handheld device or the like, it is understood that one or more external devices/resources 116 (e.g., display 120) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is an enabling system 130 for enabling coexistence of related software in accordance with embodiment(s) of the present invention. The enabling system 130 generally includes an interface system 132 for providing and displaying an interface 134, where a user may review preexisting software and class structure in the library system, as described above. The refactoring system 136 includes an extraction system 140 for extracting the classes from the normal agent package directory, and a tooling system 142 for changing the extracted classes into the tooling agent package directory.

The present invention can be offered as a business method on a subscription or fee basis. For example, one or more components of the present invention can be created, maintained, supported, and/or deployed by a service provider that offers the functions described herein for customers. That is, a service provider can be used to provide a service for enabling coexistence of related software, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for enabling coexistence of related software, comprising:
providing at least one source code class in a library system;
extracting at least one source code class from the library system;
refactoring each extracted class into a source required by an agent; and
generating a code from the source.

2. The method of claim 1, wherein the agent is a tooling agent.

3. The method of claim 1, wherein the code generated from the source, is a tooling code.

4. The method of claim 3, further comprising:
building a tooling source from the tooling code.

5. The method of claim 1, wherein the at least one source code class is stored in a normal agent package directory.

6. The method of claim 1, wherein the refactoring of the extracted class is in a tooling agent package directory.

7. The method of claim 4, wherein the building the tooling source comprises compiling into .class files.

8. Deploying an application for enabling coexistence of related software, comprising:
providing a computer infrastructure being operable to perform the method of claim 1.

9. Computer software embodied in a propagated signal for enabling coexistence of related software, the computer software comprising instructions to cause a computer system to perform the method of claim 1.

10. A system for enabling coexistence of related software, comprising:
a system for providing at least one source code class in a library system;
a system for extracting at least one source code class from the library system;
a system for refactoring each extracted class into a source required by an agent; and
a system for generating a code from the source.

11. The system of claim 10, wherein the agent is a tooling agent.

12. The system of claim 10, wherein the code generated from the source, is a tooling code.

13. The system of claim 12, further comprising:
a system for building a tooling source from the tooling code.

14. The system of claim 10, wherein the at least one source code class is stored in a normal agent package directory.

15. The system of claim 10, wherein the refactoring of the extracted class is in a tooling agent package directory.

16. The system of claim 13, wherein the building the tooling source comprises a system for compiling into .class files.

17. A program product stored on a computer readable medium for enabling coexistence of related software, the computer readable medium comprising program code for performing the steps of:
providing at least one source code class in a library system;
extracting at least one source code class from the library system;
refactoring each extracted class into a source required by an agent; and
generating a code from the source

18. A method for enabling coexistence of related software, comprising:
providing at least one source code class in a library system;
extracting at least one source code class from the library system;
refactoring each extracted class into a source required by a software routine; and
generating a code from the source.

19. The method of claim 18, wherein the software routine is an agent.

20. The method of claim 19, wherein the agent is a tooling agent.

21. The method of claim 18, wherein the related software is Java-based.
